(19) United States
(12) Patent Application Publication
(10) Pub. No.: US 2009/0223384 A1
(43) Pub. Date: Sep. 10, 2009

(54) GRILL WITH BAFFLE ARRANGEMENT TO MAKE COOKING TEMPERATURE MORE UNIFORM

(75) Inventors: Mark T. Proffitt, Greeneville, TN (US); Jim Foster, Rogersville, TN (US)

Correspondence Address: MCGUIREWOODS, LLP, 1750 TYSONS BLVD, SUITE 1800, MCLEAN, VA, 22102, US

(73) Assignee: Meco Corporation, Greeneville, TN (US)

(21) Appl. No.: 12/399,577

(22) Filed: Mar. 6, 2009

Related U.S. Application Data
(60) Provisional application No. 61/034,306, filed on Mar. 6, 2008.

(51) Int. Cl. A47J 37/07; F24C 3/12

(52) U.S. Cl. 99/447; 99/446; 126/39 R

(57) ABSTRACT

A cooking unit is disclosed. The cooking unit includes one or more burners, a cooking surface located above the burners, and a number of differently-sized baffles between the burners and the cooking surface. The baffles are configured to create a more-uniform temperature at the cooking surface.

### CROSS-REFERENCE TO RELATED APPLICATIONS

This application claims priority under 35 U.S.C. §119(e) to provisional U.S. Patent Application No. 61/034,306, filed on Mar. 6, 2008, the disclosure of which is expressly incorporated by reference herein in its entirety.

### BACKGROUND OF THE INVENTION

1. Field of the Invention

The invention is directed to a device and apparatus for improving the uniformity of heat in a grill and, in particular, improving the uniformity of heat in the grill to enhance the flavor of foods cooked therein.

2. Related Art

Grills are popular for cooking a variety of meats and other types of food. Many grills, and gas grills in particular, suffer from an uneven or non-uniform temperature across the grill or cooking surface. One attempt to solve this problem is the use of a plurality of similarly sized and substantially uniformly arranged metal baffles, flare guards, lava rocks, and/or ceramic rocks placed above the burners. These arrangements spread the heat and create a more uniform temperature. Such approaches, however, are not completely successful and still result in linear hot spots on the cooking surface and a non-uniform temperature across the cooking surface.

Accordingly, there is a need for a grill with an improved uniformity of cooking temperature and a cooking surface that is relatively free from hot spots.

### SUMMARY OF THE INVENTION

The invention meets the foregoing need and allows for a better distribution of heat from burners in a grill, which results in a significant improvement in uniformity of cooking temperature and other advantages apparent from the discussion herein.

Accordingly, in one aspect of the invention, a cooking unit is provided. The cooking unit includes a number of burners and a cooking surface above the burners. Differently-sized baffles are located between the burners and the cooking surface. The baffles are configured to produce a substantially uniform temperature at the cooking surface.

The cooking surface may be a grill. One or more of the burners may be tubular burners. The differently-sized baffles may include larger and smaller baffles. At least one baffle may be located above each burner, and one or more baffles may be located about halfway between each burner. Moreover, the larger baffles may be located above the burners while the smaller baffles may be located in between the burners.

According to another aspect of the invention, a cooking unit is provided. The cooking unit includes a number of burners and a cooking surface above the burners. A number of baffles are located between the burners and the cooking surface. Each baffle includes a bend.

The bend may be between about 60° and 135°, or the bend may be about 90°. The cooking surface may be a grill. One or more of the burners may be tubular burners. The baffles may include larger and smaller baffles. At least one baffle may be located above each burner, and one or more baffles may be located about halfway between each burner. Moreover, the larger baffles may be located above the burners while the smaller baffles may be located in between the burners.

In yet another aspect of the invention, a cooking unit is provided. The cooking unit includes a number of tubular burners and a cooking surface above the burners. A number of baffles are located between the burners and the cooking surface.

The baffles may include larger and smaller baffles. At least one of the larger baffles may be located above each burner. A smaller baffle may be located in between each of the larger baffles. The cooking surface may be a grill.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIGS. 1A, 1B, 1C, 1D, and 1E show various plan and perspective views of one aspect of the invention, which has an arrangement of larger and smaller baffles constructed according to the principles of the invention;

FIGS. 2A and 2B show another aspect of the invention, which has an arrangement of baffles constructed according to the principles of the invention;

FIGS. 3A and 3B show larger and smaller baffles of an aspect of the invention;

FIG. 4 shows an embodiment of the invention with baffles removed to show the burners of the grill;

FIGS. 5A and 5B show an arrangement of baffles partially installed above a burner;

FIGS. 6A, 6B, 6C, 6D, 6E, 6F, 6G, 6H, and 6I show different arrangements of baffles according to the principles of the invention;

FIGS. 7A and 7B show alternate geometries of baffles;

FIGS. 8A, 8B, 8C, and 8D show additional baffle geometries;

FIGS. 9A and 9B show M-shaped baffles; and

FIGS. 10A, 10B, and 10C show arc, arch, and curvilinear baffles.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

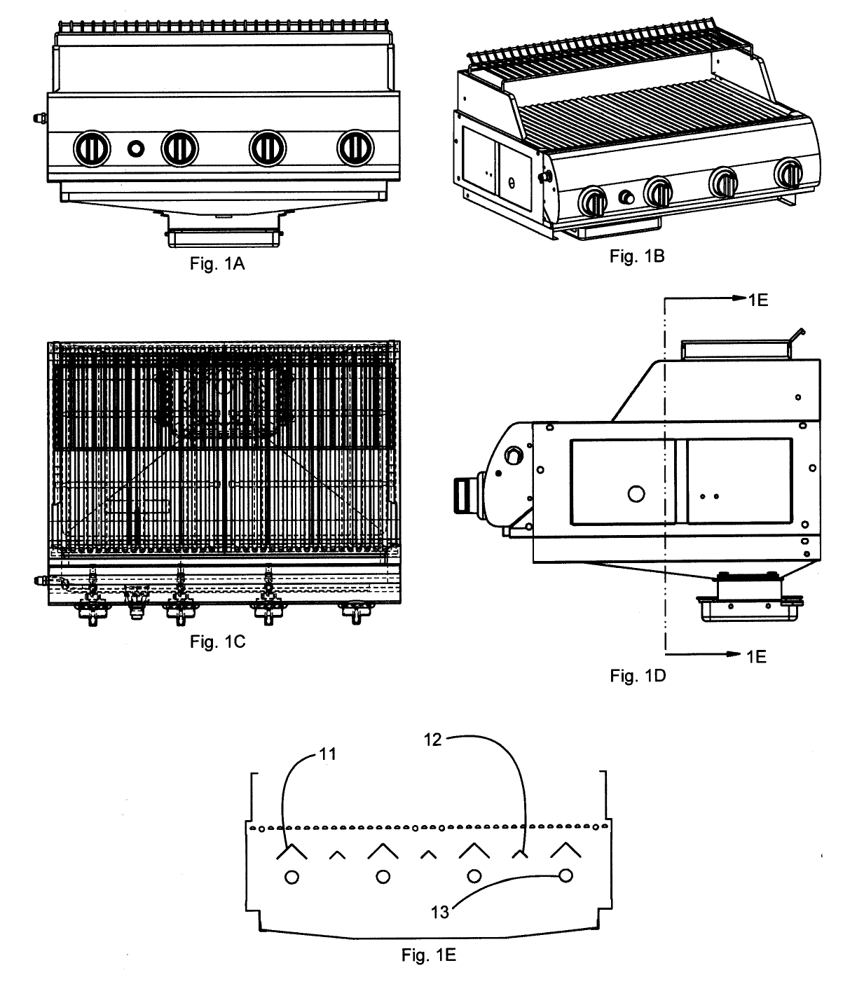

According to an aspect of the invention shown in FIG. 1, a gas grill may be constructed with a plurality of burners 13. The burners 13 may be tubular or any other shape. Although four burners are shown, more or fewer burners are contemplated. Moreover, the burners may be arranged in parallel or in any other configuration. To make the cooking temperature uniform in the grill, a plurality of baffles are placed in the grill above the burners. These arrangements may include a number of non-uniform baffles. A larger baffle 11, also referred to as a larger flavor activator, may be placed above one or more burners, and a smaller baffle 12, also referred to as a smaller flavor activator, may be disposed approximately halfway between each pair of larger flavor activators 11. Each baffle may be bent at an angle of approximately 90° and have legs of equal length. However, other arrangements and configurations of baffles, including those described below, are contemplated and within the scope of the invention.

The placement of the smaller baffles 12 in the space between the larger baffles 11 creates a disturbance in the flow of the superheated air produced by the burners. Without the smaller baffles, the superheated air would exit from under the larger flavor activators and travel straight up, creating linear hot spots on the cooking surface. With the smaller baffles in place, the superheated air is deflected, creating eddies and spreading the heat over a larger area. This results in a more uniform temperature at the cooking surface and/or improved flavor of the grilled food.

Further, the baffles may serve additional purposes. The larger baffles, for example, may prevent grease produced by cooking food from falling on and damaging burners. Baffles may also vaporize falling liquids, thereby creating smoke to enhance the flavor of the food. A steep angle may allow grease to run off quickly rather than standing and burning near the food. A steep angle and a reduced size of the smaller baffles also allows more heat to be used, thereby igniting and immediately shedding grease that is mostly incinerated before it reaches the bottom pan.

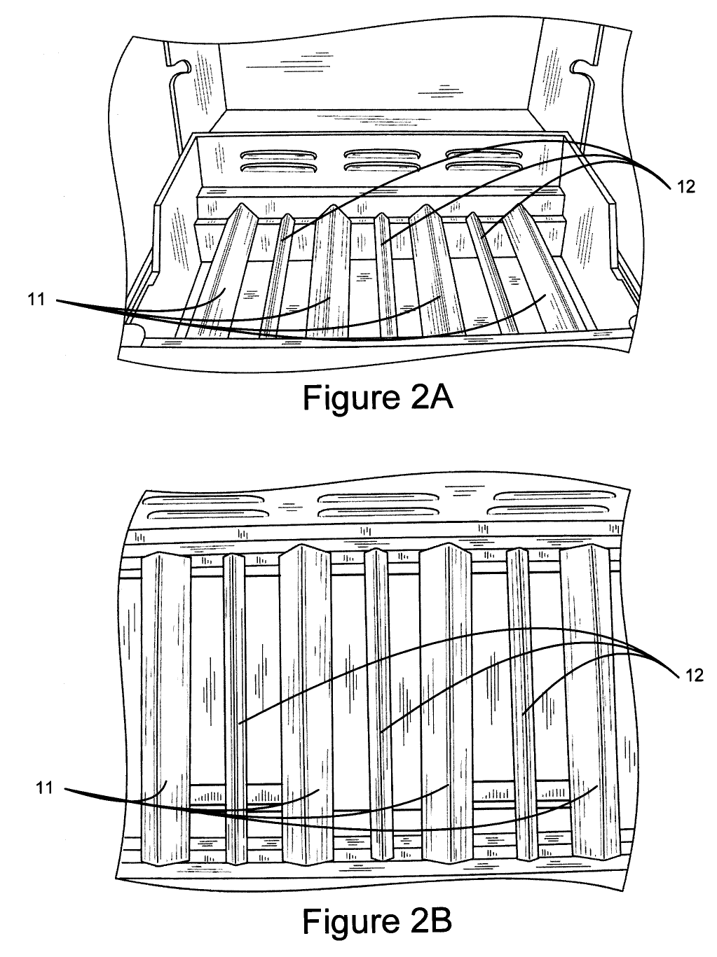

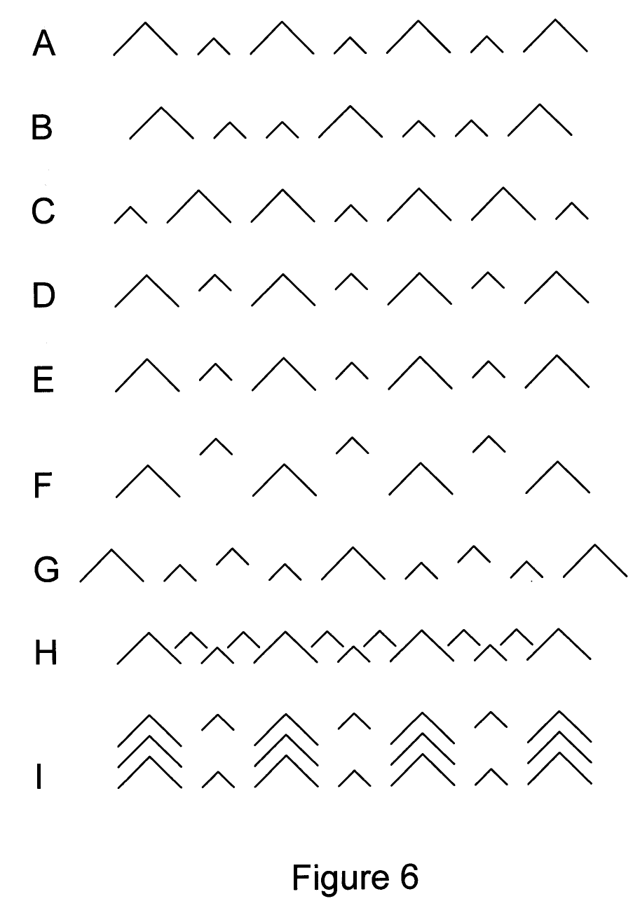

FIG. 2 shows an alternate aspect of the grill with the cooking surface removed, and FIG. 3 shows a larger baffle 11 and a smaller baffle 12 from this aspect of the invention. While the baffles shown here possess a simple bent shape with sides of equal length and an angle of roughly 120°, other shapes, configurations, and arrangements are contemplated and within the scope of the invention, as described below with respect to FIGS. 6, 7, 8, 9, and 10.

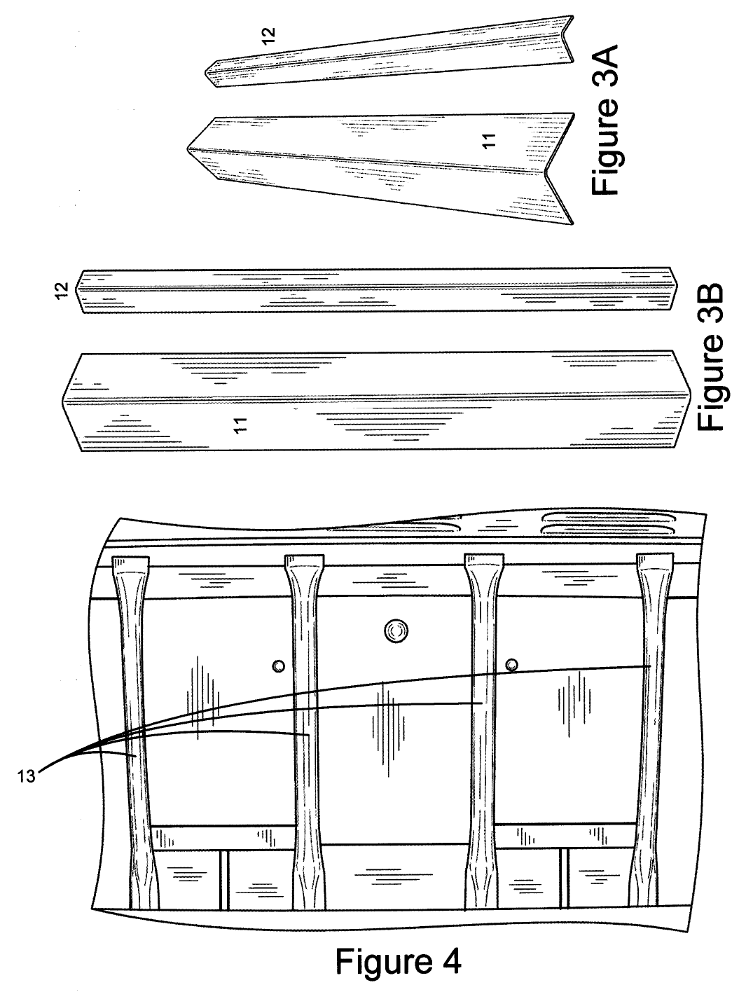

FIG. 4 shows an aspect of the grill with the cooking surface and baffles removed to reveal the burners. While the aspect shown here includes four tubular burners, other types, arrangements, and numbers of burner are contemplated and within the scope of the invention. For example, the burners may be arranged in parallel, as shown, e.g., in FIG. 4, or they may be arranged in a square configuration. Rather than tubular burners, the burners may be circular or any other shape appropriate to a particular application of the invention. Even though four burners are shown in FIG. 4, any number of burners may be used, including for example purposes only but not limited to one, two, three, five, six, or eight burners.

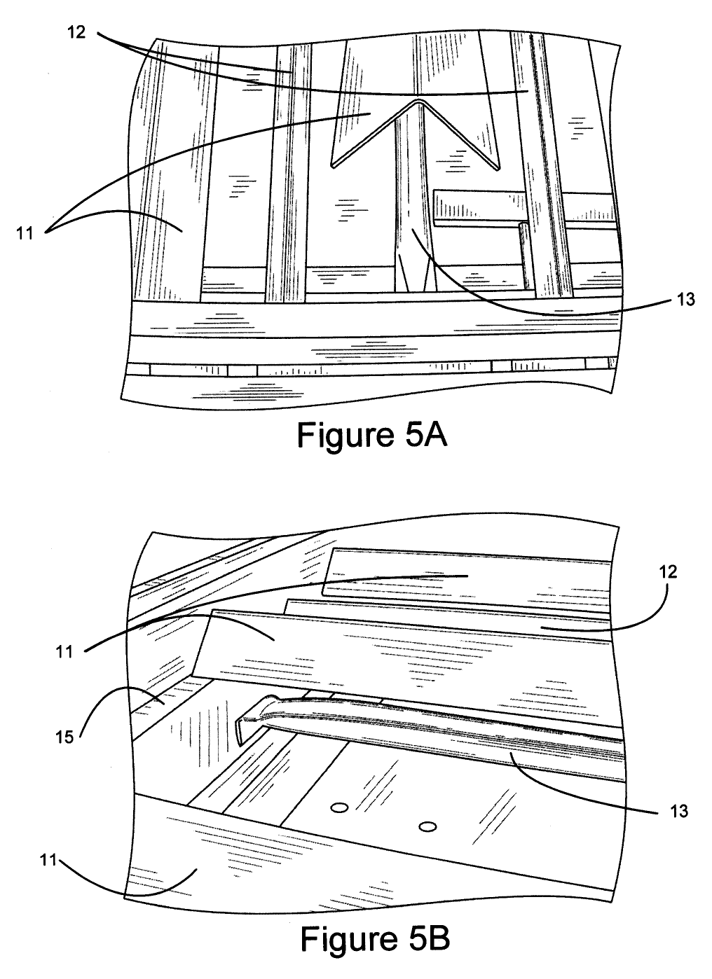

FIGS. 5A and 5B show an aspect of the invention with the baffles partially installed above tubular burners. FIG. 5A, in particular, shows an arrangement of larger baffles above each tubular burner. Between each pair of larger baffles is a smaller baffle. Other arrangements and configurations are contemplated, as described below with respect to FIGS. 6-10. FIG. 5B is a different-angle view of the same arrangement of larger and smaller baffles. FIG. 5B also shows the support shelf 15 that holds the baffles in place above the burners. Any means known to one skilled in the art may be used to support the baffles in place of the support shelf 15. For example, the baffles may be held in position by welding, brackets, support pillars, tabs, screws, cutouts, or the like.

FIG. 6 shows a variety of arrangements of larger and smaller baffles. As will be appreciated by one of ordinary skill in the art, it is possible to combine aspects of the various arrangements represented in the figures with one another to arrive at new arrangements that are within the scope and spirit of the invention. While the baffles shown in this and other figures may have an angle of approximately 90°, any angle from about 30° to about 180° is contemplated and may used without departing from the scope and spirit of the invention.

FIG. 6A shows alternating larger and smaller baffles while FIGS. 6B and 6C show additional, non-limiting patterns for arranging baffles. FIG. 6B shows a pattern of one larger baffle followed by two smaller baffles. FIG. 6C shows one smaller baffle followed by two larger baffles. Additional patterns are contemplated and within the scope of the invention.

While FIG. 6A shows baffles that are vertically aligned at their bottoms, FIGS. 6D, 6E, and 6F show alternate, non-limiting vertically spaced arrangements. FIG. 6D shows baffles that are vertically aligned at their tops, while those in 6E are aligned at their midpoints. FIG. 6F shows an arrangement with no vertical overlap between the larger and smaller baffles. In this figure, the bottoms of the smaller baffles are above the tops of the larger baffles, although arrangements wherein the smaller baffles are below the larger baffles are also contemplated and within the scope of the invention.

Moreover, it is not necessary for all baffles of a particular size to be at the same height. FIG. 6G shows such an arrangement. Some smaller baffles are vertically aligned with the tops of the larger baffles while others are aligned with the bottoms of the larger baffles. In alternate arrangements, some smaller baffles may be placed above or below the tops and bottoms, respectively, of the larger baffles.

FIG. 6H is similar to FIG. 6G. The primary difference is less horizontal distance between the baffles, which results in a “total occlusion” arrangement. In this arrangement, there is no unobstructed vertical line from the top of the grill to its bottom. The baffle at either end may or may not be attached to the side of the grill, thereby forcing hot air from the burners to pass through the baffle arrangement as it rises to the cooking surface.

FIG. 6I shows an arrangement that includes stacked baffles. In such an arrangement, baffles are placed in vertical stacks. The stacks in FIG. 6 are horizontally aligned, and each stack has only one size of baffle. In general, stacks may be aligned or unaligned, and they may include both larger and smaller baffles.

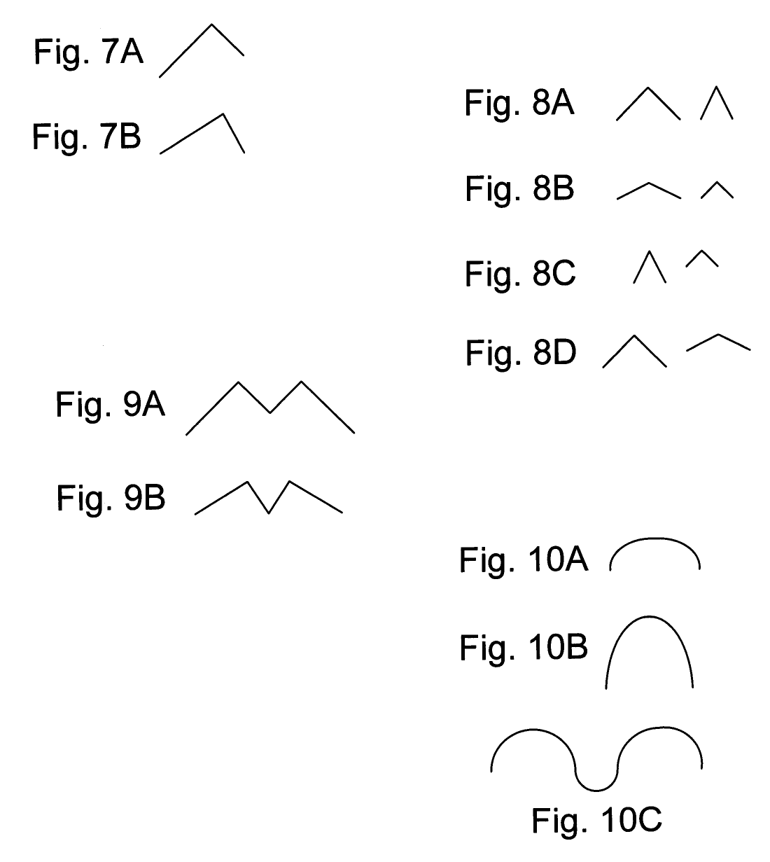

FIG. 7 shows non-limiting examples of baffles with uneven legs. Both larger and smaller baffles may be configured with uneven legs. For example, a baffle with unequal legs may be arranged such that one leg extends below the other, as seen in FIG. 7A. Alternatively, the baffle may be arranged such that the legs descend to the same level but the bend in the baffle is shifted to one side of the horizontal midpoint between the ends of the legs, as seen in FIG. 7B.

FIG. 8 shows exemplary pairs of a larger baffle (on the left) and a smaller baffle (on the right) that have been configured to have at least one equal dimension. FIGS. 8A and 8B both show a larger baffle and a smaller baffle that have equal height. The baffles in FIGS. 8C and 8D have equal width.

Baffles may have other geometries than the simple bent shape shown in prior figures. FIG. 9 provides two non-limiting examples of baffles with an M-shaped configuration. Baffles may alternately have different polygonal shapes, such as a three, four, or five sided shape. Rather than hard angles, baffles may have an arch, arc, or curvilinear shape as shown in FIG. 10. As would be understood by one skilled in the art, the alternate geometries shown in FIGS. 7-10 and described above may be combined with the basic bent-shape geometry shown in FIG. 6 or with any other alternate geometry. Such combinations may be arranged in any arrangement shown, e.g., in FIG. 6 or as otherwise required for a particular embodiment, aspect, or design goal.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A cooking unit comprising:
a plurality of burners;
a cooking surface positioned above the plurality of burners; and
a plurality of differently-sized baffles disposed between the plurality of burners and the cooking surface, wherein the plurality of baffles is configured to produce a substantially uniform temperature at the cooking surface.

2. The cooking unit of claim 1, wherein the cooking surface is a grill.

3. The cooking unit of claim 1, wherein the plurality of burners comprises at least one tubular burner.

4. The cooking unit of claim 1, wherein the plurality of baffles comprises larger baffles and smaller baffles

5. The cooking unit of claim 1, wherein at least one baffle is disposed above each burner.

6. The cooking unit of claim 1, wherein at least one baffle is disposed about halfway between each burner.

7. The cooking unit of claim 4, wherein at least one larger baffle is disposed above each burner and at least one smaller baffle is disposed about halfway between each burner.

8. A cooking unit comprising:
a plurality of burners;
a cooking surface positioned above the plurality of burners; and
a plurality of baffles disposed between the plurality of burners and the cooking surface, wherein each baffle in the plurality of baffles comprises a bend.

9. The cooking unit of claim 8, where in the bend is between about 60° and about 135°.

10. The cooking unit of claim 9, wherein the bend is about 90°.

11. The cooking unit of claim 8, wherein the cooking surface is a grill.

12. The cooking unit of claim 8, wherein the plurality of burners comprises at least one tubular burner.

13. The cooking unit of claim 8, wherein the plurality of baffles comprises larger baffles and smaller baffles

14. The cooking unit of claim 8, wherein at least one baffle is disposed above each burner.

15. The cooking unit of claim 8, wherein at least one baffle is disposed about halfway between each burner.

16. The cooking unit of claim 13, wherein at least one larger baffle is disposed above each burner and at least one smaller baffle is disposed about halfway between each burner.

17. A cooking unit comprising:
a plurality of tubular burners;
a cooking surface positioned above the plurality of tubular burners; and
a plurality of baffles disposed between the plurality of tubular burners and the cooking surface.

18. The cooking unit of claim 17, wherein the plurality of baffles comprises larger baffles and smaller baffles

19. The cooking unit of claim 18, wherein at least one larger baffle is disposed above each tubular burner and at least one smaller baffle is disposed about halfway between each tubular burner.

20. The cooking unit of claim 17, wherein the cooking surface is a grill.
